(19) United States
(12) Patent Application Publication
(10) Pub. No.: US 2015/0096983 A1
(43) Pub. Date: Apr. 9, 2015

(54) FUEL NOZZLE-RECEIVING ASSEMBLY

(71) Applicant: ILLINOIS TOOL WORKS INC., Glenview, IL (US)

(72) Inventors: Melissa Moy, Schaumburg, IL (US); Stephen Sperando, Glen Ellyn, IL (US); Paul M. Sutenbach, Highland Park, IL (US)

(73) Assignee: ILLINOIS TOOL WORKS INC., Glenview, IL (US)

(21) Appl. No.: 14/400,000

(22) PCT Filed: May 17, 2013
(86) PCT No.: PCT/US2013/041526

§ 371 Date: Nov. 10, 2014

Related U.S. Application Data
(60) Provisional application No. 61/648,158, filed on May 17, 2012.

(51) Int. Cl. B60K 15/04

(52) U.S. Cl. CPC B60K 15/04
USPC 220/86.2

(57) ABSTRACT

A fuel nozzle-receiving assembly is configured to be operatively connected to a fuel fill line of a fuel intake system of a vehicle. The assembly may include a main outer body, a pressure relief member, and a seal member. The pressure relief member may be secured to and within the main outer body and may include at least one valve operatively connected to at least one relief passage. The valve(s) is configured to open to allow fluid pressure to be released through the at least one relief passage when the fluid pressure exceeds a pressure threshold. The seal member may be secured to the pressure relief member and may define a central opening configured to receive a fuel nozzle. The seal member is configured to sealingly engage an outer shaft of the fuel nozzle to prevent fuel from back-flowing out of the fuel fill line and air from passing into the fuel fill line.

### RELATED APPLICATIONS

The present application relates to and claims priority benefits from U.S. Provisional Patent Application No. 61/648,158 entitled “Fuel Nozzle Receiving System,” filed May 17, 2012, which is hereby incorporated by reference in its entirety.

### FIELD OF EMBODIMENTS OF THE DISCLOSURE

Embodiments of the present disclosure generally relate to a fuel nozzle-receiving assembly.

### BACKGROUND

Various vehicles, such as automobiles, include fuel systems having a tank configured to retain fuel, such as gasoline or diesel fuel, and a fuel fill pipe that serves as an inlet for supplying fuel to the tank from a fuel nozzle of a refueling station. In general, a fuel fill pipe includes an opening that may be exposed during refueling to receive the nozzle. An exposed end portion of the fuel pipe is of sufficient size to receive a discharge tube of a refueling nozzle. The nozzle typically fits relatively loosely in the fuel fill pipe so that the nozzle may be quickly and easily inserted and removed from the fuel fill pipe.

During a refueling operation, air may pass into the fuel fill pipe or tank, while hydrocarbons tend to escape from the fuel fill pipe or tank into the environment. Under normal vehicle engine operation, canisters adapted to capture hydrocarbons are evacuated, typically due to vacuum-like conditions generated through engine operation. In hybrid applications or other alternative engine operation systems, evacuation or purging of the canisters occurs less frequently, due to decreased engine operation.

Typically, refueling results in the fuel tank or system being pressurized. Under normal conditions, fuel nozzles are adapted to shut off once the tank is full. However, if there is a malfunction, or if a shut-off device is overcome, such as through operator manipulation, fuel may flow or splash out of the fuel pipe. If too much pressure builds, fuel can forcibly eject from the fuel pipe and cause the nozzle to also forcibly eject from the end of the fuel pipe.

### SUMMARY OF EMBODIMENTS OF THE DISCLOSURE

Embodiments of the present disclosure provide fuel nozzle-receiving assemblies that prevent fuel backflow and dangerous pressure build-up within a fuel fill line or tank.

Certain embodiments of the present disclosure provide a fuel nozzle-receiving assembly configured to be operatively connected to a fuel fill line of a fuel intake system of a vehicle. The assembly may include a main outer body, a pressure relief member, and a seal member.

The pressure relief member may be secured to and within the main outer body. The pressure relief member may include at least one valve operatively connected to at least one relief passage. The valve(s) may be configured to open to allow fluid pressure (such as that caused by trapped hydrocarbons) to be released through the relief passage(s) when the fluid pressure exceeds a pressure threshold.

The seal member may be secured to the pressure relief member. The seal member may define a central opening configured to receive a fuel nozzle. The seal member may be configured to sealingly engage an outer shaft of the fuel nozzle to prevent fuel from back-flowing out of the fuel fill line and air from passing into the fuel fill line.

The valve(s) may include an umbrella valve having opposed flaps that cover the relief passage(s) in a closed position. Optionally, the valve(s) may include an anchored portion operatively connected to a valve member configured to pivot into and out of the at least one relief passage.

The assembly may also include a nozzle guide configured to guide the fuel nozzle into the central opening. The seal member may be securely sandwiched between the pressure relief member and the nozzle guide.

The assembly may also include a gasket secured to a portion of the pressure relief member. The gasket may provide a sealing interface between the pressure relief member and the main outer body. The sealing interface prevents fluid, whether liquid or gas, from passing therethrough. The pressure relief member and the gasket may be integrally overmolded together as a single piece.

The pressure relief member may include at least one securing member that is securely retained within at least one retaining passage formed through the seal member. The pressure relief member and the seal member may be integrally overmolded together as a single piece.

The seal member may include a plurality of nozzle engagers surrounding the central opening. The seal member may include a first seal member component overlaying a second seal member component. A first set of nozzle engagers of the first seal member may overlap a second set of nozzle engagers of the second seal member.

Certain embodiments of the present disclosure provide a fuel nozzle-receiving assembly configured to be operatively connected to a fuel fill line of a fuel intake system of a vehicle that may include a pressure relief member and a seal member.

Certain embodiments of the present disclosure provide a fuel nozzle-receiving assembly that may include a main outer body configured to be secured on or within a portion of the fuel fill line, a pressure relief member, a gasket, a seal member, and a nozzle guide. The pressure relief member may include a plurality of valves operatively connected to a plurality of relief passages, and at least one securing member. The gasket may be secured to a portion of the pressure relief member. The gasket provides a sealing interface between the pressure relief member and the main outer body. The seal member may be secured to the pressure relief member and may include at least one retaining passage configured to securely retain the at least one securing member. The nozzle guide may be configured to guide the fuel nozzle into the central opening. The seal member may be securely sandwiched between the pressure relief member and the nozzle guide.

### BRIEF DESCRIPTION OF SEVERAL VIEWS OF THE DRAWINGS

FIG. 1 illustrates a front view of a fuel nozzle-receiving assembly, according to an embodiment of the present disclosure.

FIG. 2 illustrates a front view of a nozzle guide, according to an embodiment of the present disclosure.

FIG. 3 illustrates a front view of a seal member, according to an embodiment of the present disclosure.

FIG. 4 illustrates a front view of a pressure relief member, according to an embodiment of the present disclosure.

FIG. 5 illustrates a front view of an umbrella valve, according to an embodiment of the present disclosure.

FIG. 6 illustrates a front view of a gasket, according to an embodiment of the present disclosure.

FIG. 7 illustrates a front view of a pressure relief member and seal member secured within a main outer body of a fuel nozzle-receiving assembly, according to an embodiment of the present disclosure.

FIG. 8 illustrates a transverse cross-sectional view of a fuel nozzle-receiving assembly, according to an embodiment of the present invention.

FIG. 9 illustrates an isometric rear view of a fuel nozzle-insertion assembly, according to an embodiment of the present disclosure.

FIG. 10 illustrates an isometric rear view of an umbrella valve secured to a set of relief passages, according to an embodiment of the present disclosure.

FIG. 11 illustrates a lateral view of an umbrella valve secured to a set of relief passages, according to an embodiment of the present disclosure.

FIG. 12 illustrates an isometric front view of a pressure relief member, according to an embodiment of the present disclosure.

FIG. 13 illustrates an isometric front view of a seal member secured to a pressure relief member, according to an embodiment of the present disclosure.

FIG. 14 illustrates an isometric rear view of a seal member secured to a pressure relief member, according to an embodiment of the present disclosure.

FIG. 15 illustrates a front view of a fuel nozzle-receiving assembly, according to an embodiment of the present disclosure.

FIG. 16 illustrates a front view of a seal member, according to an embodiment of the present disclosure.

FIG. 17 illustrates a front view of a seal member half, according to an embodiment of the present disclosure.

FIG. 18 illustrates an interior transverse cross-sectional view of a fuel nozzle-receiving assembly, according to an embodiment of the present disclosure.

FIG. 19 illustrates an isometric front view of a pressure relief member, according to an embodiment of the present disclosure.

FIG. 20 illustrates an isometric front view of a pressure relief member with valves removed, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

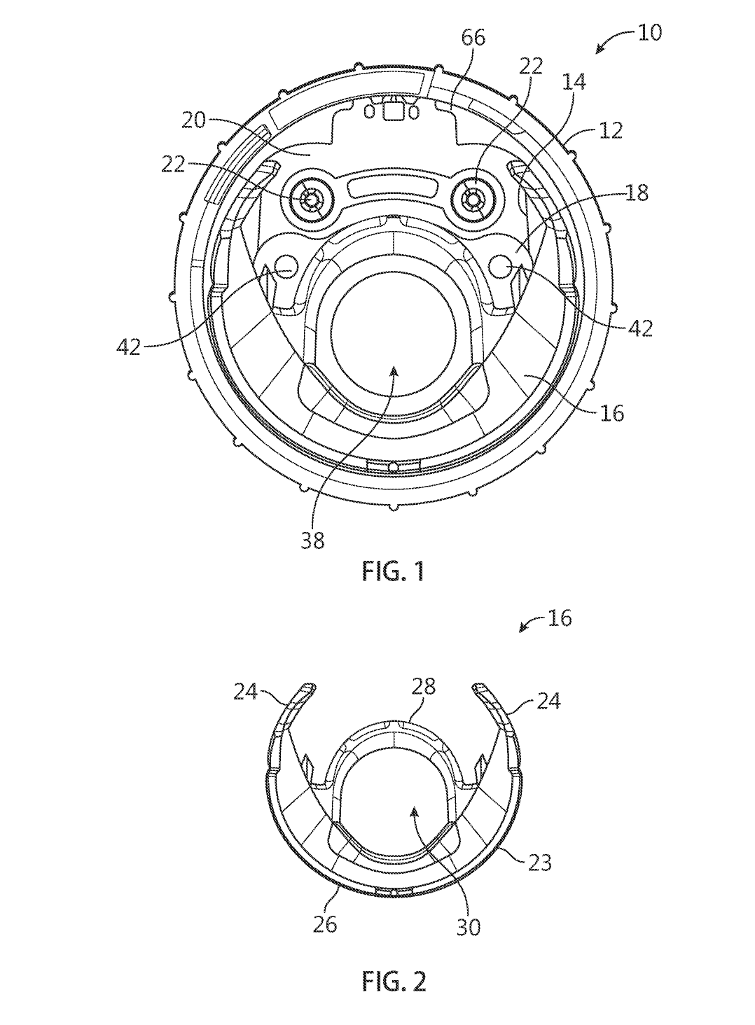

FIG. 1 illustrates a front view of a fuel nozzle-receiving assembly 10, according to an embodiment of the present disclosure. The fuel nozzle-receiving assembly 10 may be or include a primary shutoff valve, for example. The fuel nozzle-receiving assembly 10 is configured to be secured to an outer end of a fuel fill pipe (not shown) that, in turn, connects to a fuel tank (not shown), such as shown and described in U.S. Pat. No. 7,415,997, entitled “Seal Assembly for Fuel Fill Pipes,” which is hereby incorporated by reference in its entirety. The fuel nozzle-receiving assembly 10 is configured to receive a nozzle of a fuel supply pump so that fuel may be supplied to the fuel tank.

The fuel nozzle-receiving assembly 10 includes a main outer body 12, which may be shaped as a cylinder. However, the main outer body 12 may be formed in various other shapes and sizes. The main outer body 12 includes an interior passage 14. The main outer body 12 may be formed of various materials, such as plastic, metal, and/or the like.

The main outer body 12 retains a nozzle guide 16, a seal member 18, a pressure relief member 20 that that may include one or more valves 22, and a gasket (hidden from view in FIG. 1). The seal member 18 may be sandwiched between the nozzle guide 16 and the pressure relief member 20. The pressure relief member 20 may be sandwiched between the seal member 18 and the gasket.

FIG. 2 illustrates a front view of the nozzle guide 16, according to an embodiment of the present disclosure. The nozzle guide 16 includes a barrier body 23 that may be formed as a semi-circle, and is configured to be received and retained by reciprocal features within the main outer body 12 (shown in FIG. 1). The barrier body 23 includes opposed lateral wings 24 that integrally connect to an arcuate beveled or funneled lead-in base 26 that connects to an internal arch 28 defining a nozzle opening 30. The lateral wings 24 are configured to securely connect to internal features of the main outer body 12 (shown in FIG. 1), such as through an interference fit, a snap fit, separate fasteners, bonding, and/or the like. The lead-in base 26 is configured to direct a fuel nozzle toward the nozzle opening 30. The funneled nature of the lead-in base 26 ensures that the nozzle is automatically directed toward the nozzle opening 30. As the nozzle moves into the nozzle opening 30, the lead-in base 26 and the internal arch 28 provide a barrier past which the nozzle housing of the fuel pump cannot pass. As such, the nozzle guide 16 allows the fuel nozzle to be inserted into the nozzle opening 30, while at the same time ensuring that the fuel nozzle is inserted a controlled distance into the fuel nozzle-receiving assembly 10 (shown in FIG. 1).

The nozzle guide 16 presses and holds the seal member 18 into the pressure relief member 20. The seal member 18 may be securely sandwiched between the nozzle guide 16 and the pressure relief member 20.

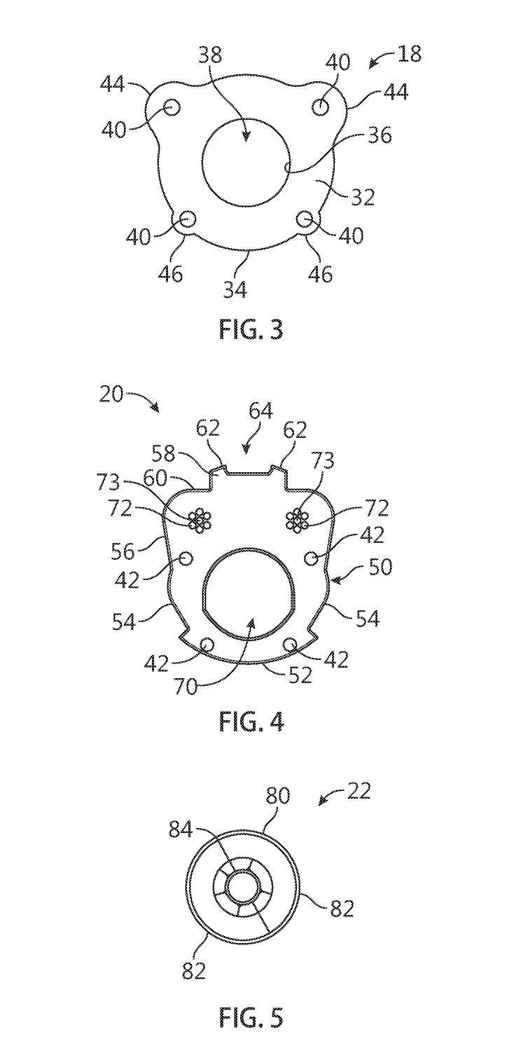

FIG. 3 illustrates a front view of the seal member 18, according to an embodiment of the present disclosure. The seal member 18 may be a flat, planar sheet of elastomeric material, such as rubber, thermoplastic elastomer (TPE), or the like, for example. A seal member formed of TPE may provide a chemical bond when overmolded onto one or both of the nozzle guide 16 and/or the pressure relief member 20 (shown in FIG. 1). As such, the chemical bond may provide a robust seal that prevents any leaks between the nozzle guide 16, the seal member 18, and the pressure relief member 20.

The seal member 18 includes a generally annular body 32 having an outer circumferential edge 34 and an interior circumferential edge 36 defining a central opening 38. Retaining passages 40 may be formed proximate to the outer edge 34. The retaining passages 40 are configured to receive and retain reciprocal securing members 42 of the pressure relief member 20 (shown in FIG. 1). In general, the number and placement of retaining passages 40 generally corresponds to the number and placement of the securing members 42. The seal member 18 may include expanded portions 44 and 46 at the outer edge 34 bordering the retaining passages 40. The expanded portions 44 and 46 may provide strength and resilience to the seal member 18 around the retaining passages 40, thereby ensuring that the material of the seal member 18 does not crack or split open near and/or into the retaining passages 40.

The interior edge 36 is generally sized and shaped to provide a sealing interface around an outer shaft of a fuel nozzle. As such, the diameter of the interior edge 36 may be less than the diameter of a fuel nozzle. The seal member 18 provides a seal around the fuel nozzle as the fuel nozzle is inserted into the fuel nozzle-receiving assembly 10 (shown in FIG. 1). As such, the seal member 18 prevents gases and fuel within a fuel tank or fuel fill pipe from escaping therefrom. Further, the seal member 18 prevents air from passing into the fuel fill line and the fuel tank.

FIG. 4 illustrates a front view of the pressure relief member 20, according to an embodiment of the present disclosure. The pressure relief member 20 includes a relief body 50 that may include an arcuate base 52 integrally connected to lateral beams 54, which, in turn, may integrally connect to an upper cross beam 56. A connection bar 58 may upwardly extend from an upper edge 60 of the upper cross beam 56. The connection bar 58 may include lateral posts 62 separated by a central recess 64. The connection bar 58 is configured to attach to a reciprocal feature 66 of the main outer body 12 (shown in FIG. 1), while the lower arcuate base 52 is configured to securely attach to a reciprocal feature of the main outer body 12.

The securing members 42 outwardly extend from a front surface of the pressure relief member 20. The securing members 42 are configured to be received and retained within the retaining passages 40 (shown in FIG. 3) of the seal member 18. As such, the seal member 18 is configured to securely mount to the front surface of the pressure relief member 20.

A central opening 70 is formed through the pressure relief member 20, and is configured to be aligned with the central opening 38 of the seal member 18 (shown in FIG. 3). The central opening 70 is configured to allow a fuel nozzle to pass therethrough.

Relief passages 72 are formed through the upper cross beam 56. As shown, two sets of six relief passages 72 are formed through the cross beam 56. The Each set of relief passages 72 surrounds a central valve-retaining passage 73, which is configured to securely retain a securing post of a valve, such as the valve 22, which may be an umbrella valve, for example. More or less sets of relief passages 72 may be used. Further, each set of relief passages 72 may include more or less than six passages. The pressure relief member 20 and the valves 22 are configured to provide pressure relief under a failed nozzle condition, as explained below.

FIG. 5 illustrates a front view of a valve 22, according to an embodiment of the present disclosure. The valve 22 may be an umbrella valve 22 that includes a generally circular cross-sectional body 80 having opposed flaps 82 separated by a crease 84. The flaps 82 are configured to cover the relief passages 72. In operation, when internal gas pressure exceeds a certain threshold, the flaps 82 flap open about the crease 84, thereby allowing fluid, such as gaseous hydrocarbons, to flow out of the relief passages 72. The umbrella valve 22 is configured to be operatively connected to the pressure relief member 20 over one set of relief passages 72, as shown in FIG. 1.

The umbrella valve 22 may be an elastomeric valve that includes a diaphragm-shaped sealing disk. The umbrella valve 22 may generally be utilized as a backflow prevention device, one-way valve, or check valve. When mounted to a set of relief passages 72, the convex diaphragm flattens out against the valve seat and absorbs a certain amount of seat irregularities and provides a sealing force. The umbrella valve 22 allows forward flow once the head pressure creates enough force to lift the convex diaphragm from the seat (for example, the areas around the relief passages 72), thereby allowing flow at a predetermined pressure in one direction, while preventing back flow in the opposite direction. While embodiments of the present disclosure describe umbrella valves, various other types of backflow valves may be used in place of the umbrella valves 22. For example, standard check valves may be used with respect to the fuel nozzle-receiving assembly 10.

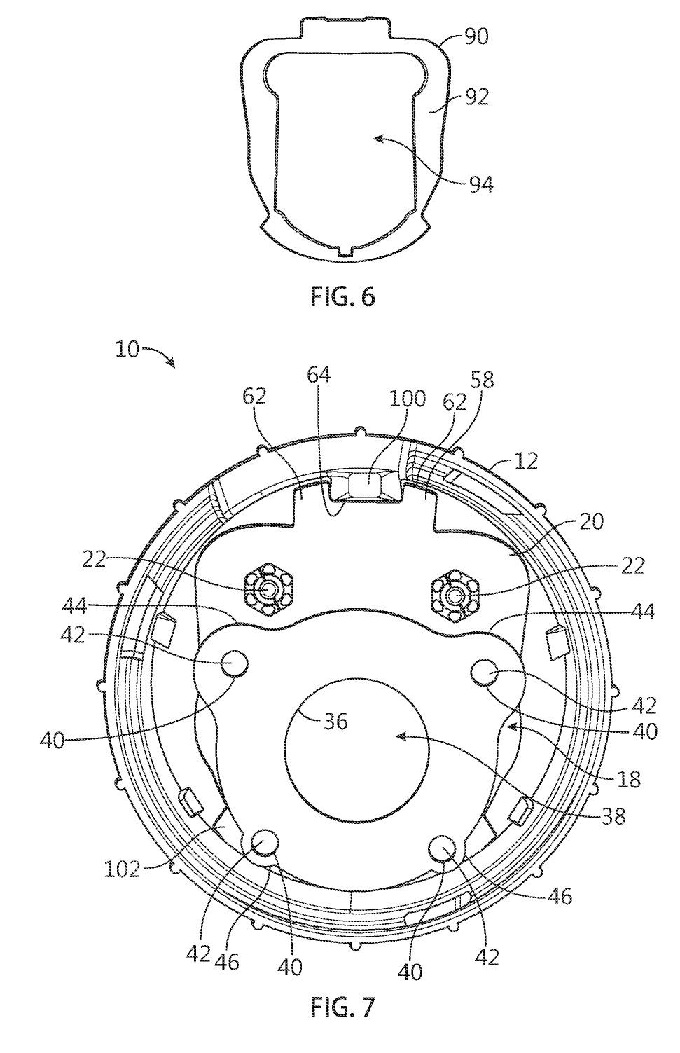

FIG. 6 illustrates a front view of a gasket 90, according to an embodiment of the present disclosure. The gasket 90 includes an outer frame 92 defining an interior opening 94. The gasket 90 may be formed of a flat, planar elastomeric material, such as rubber, and is configured to securely connect to the main outer body 12 (shown in FIG. 1) and provide a seal around a periphery of the pressure relief member 20. As such, the gasket 90 prevents fluid, such as liquid or gas, from infiltrating around a periphery of the pressure relief member 20.

FIG. 7 illustrates a front view of the pressure relief member 20 and the seal member 18 secured within the main outer body 12 of the fuel nozzle-receiving assembly 10, according to an embodiment of the present disclosure. For the sake of clarity, the nozzle guide 16 is not shown in FIG. 7. As shown, the seal member 18 is secured to the pressure relief member 20 by way of the securing members 42 of the pressure relief member 20 being securely retained within the retaining passages 40 of the seal member 18. Accordingly, the seal member 18 is secured from movement in relation to the pressure relief member 20. Each securing member 42 may include a cylindrical post that interferingly fits and/or is snapably secured within a reciprocal retaining passage 40. However, the sizes and shapes of the retaining passages 40 and the securing members 42 may be different than shown.

The connection bar 58 of the pressure relief member 20 may securely attach to protuberance 100, such as a barb, stud, or the like, of the main outer body 12. For example, the lateral posts 62 may secure to outer edges of the protuberance 100, while the protuberance 100 fits within the central recess 64 of the connection bar 58. Similarly, the lower arcuate base 52 of the pressure relief member 20 may securely mount within a reciprocal recess 102 formed through a lower interior portion of the main outer body 12. In general, outer portions of the pressure relief member 20 may sealingly secure and connect to interior portions of the main outer body 12.

The seal member 18 is configured to provide a sealing engagement with an outer shaft of a fuel nozzle. For example, the outer diameter of the fuel nozzle may be greater than the central opening 38. As the fuel nozzle is inserted into the central opening 38, the flexible nature of the seal member 18 allows the fuel nozzle to deflect the interior edge 36 of the seal member 18, which sealingly engages the outer surface of the fuel nozzle as the nozzle is further urged into the opening 38. As such, the seal member 18 may provide a sealing, interference fit with the outer shaft of the fuel nozzle. The robust seal between the seal member 18 and the fuel nozzle prevents leaks therebetween. As such, fuel is prevented from back-flowing past the sealing interface between the seal member 18 and the fuel nozzle, while air is prevented from passing into the fuel fill line.

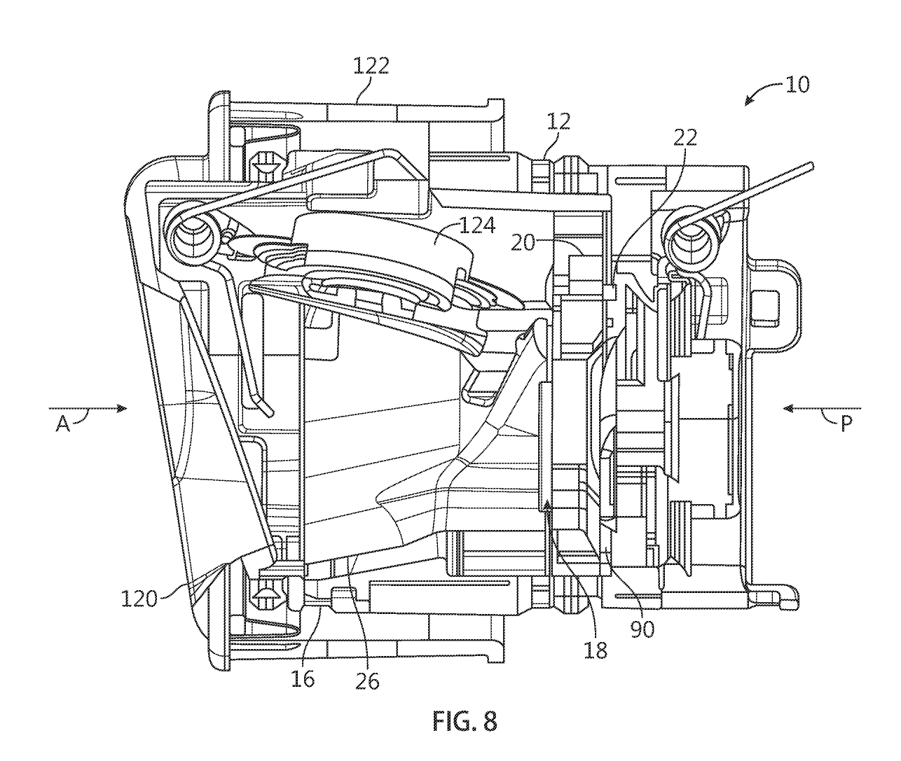

FIG. 8 illustrates a transverse cross-sectional view of the fuel nozzle-receiving assembly 10, according to an embodiment of the present invention. The fuel nozzle-receiving assembly 10 may be secured or and/or within a fuel intake system 120 of a vehicle 122. The fuel intake system 120 may be include a pivotal cover 124 configured to be pivoted open upon inward urging of a fuel nozzle. The fuel nozzle is inserted into the fuel nozzle-receiving assembly 10 in the direction of arrow A, and is guided into the central opening 38 (shown in FIGS. 1, 3, and 7) by way of the nozzle guide 16. For example, the funneled lead-in walls 26 guide the fuel nozzle into the central opening 38. As described above, the nozzle guide 16 allows the fuel nozzle to be inserted into the fuel nozzle-receiving assembly 10 at a controlled depth.

The seal member 18 sealingly engages an outer surface of the fuel nozzle, as described above. As such, internal gases and fuel are prevented from retreating past the sealing interface between the seal member 18 and the fuel nozzle. The seal member 18 seals around an outer shaft of the fuel nozzle, thereby preventing hydrocarbons from escaping from the fuel pipe during a refueling operation.

The gasket 90 provides a sealing interface between an outer periphery of the pressure relief member 20 and the main outer body 12, as described above. Accordingly, internal gases and fuel are prevented from passing around the pressure relief member 20.

Internal fuel tank pressure may be exerted into the fuel nozzle-receiving assembly 10 in the direction of arrow P. At lower pressures, the seal member 18 and the gasket 90 provide sealing interfaces, as described above, until pressure that exceeds a particular threshold is reached within the fuel fill line and/or tank. Once the pressure exceeds the particular threshold, the umbrella valves 22 may open to provide pressure relief. The umbrella valves 22 may be designed and configured to open at a particular pressure threshold.

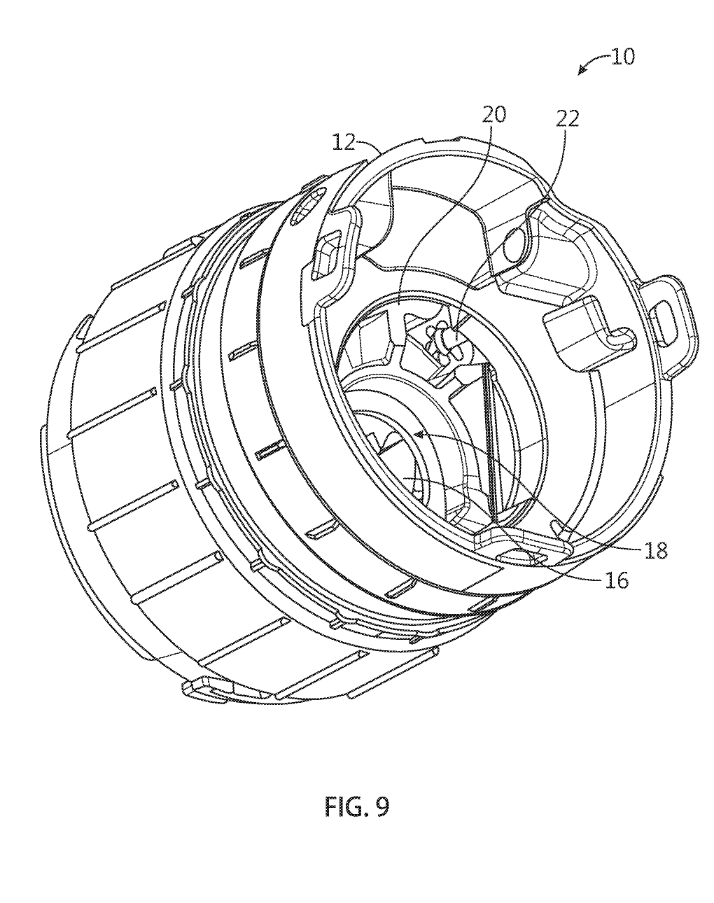

FIG. 9 illustrates an isometric rear view of the fuel nozzle-insertion assembly 10, according to an embodiment of the present disclosure. The pressure relief member 20 may be sealed to an interior portion of the main outer body 12. As pressure builds up within a fuel tank under a failed nozzle condition, the umbrella valves 22 open to allow the pressure to be released through the relief passages 72 (shown in FIG. 4).

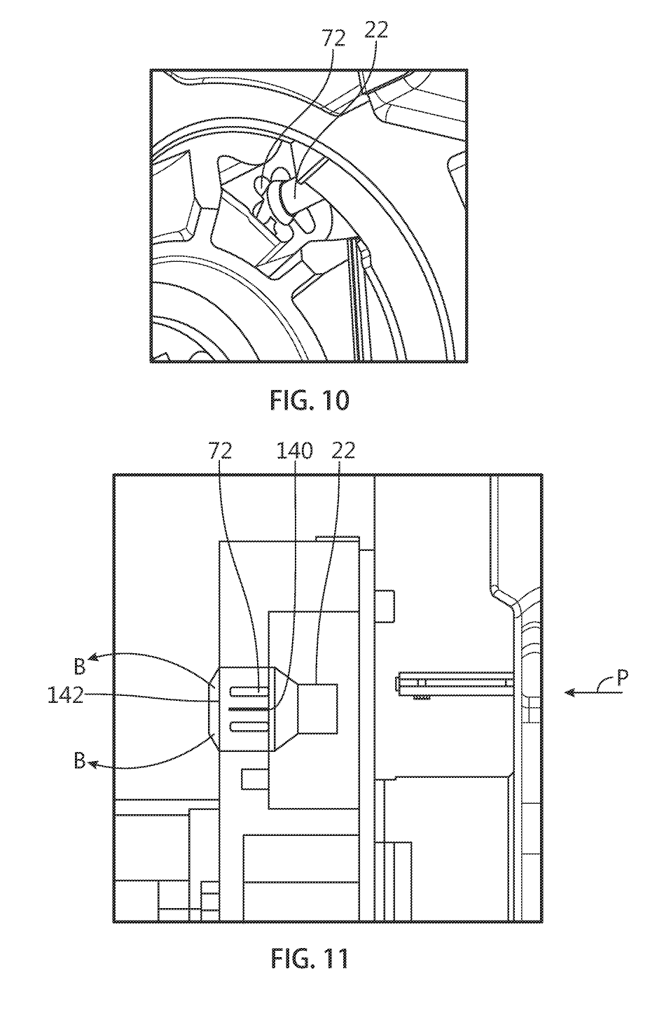

FIG. 10 illustrates an isometric rear view of an umbrella valve 22 secured to a set of relief passages 72, according to an embodiment of the present disclosure. FIG. 11 illustrates a lateral view of the umbrella valve 22 secured to the set of relief passages 72. Referring to FIGS. 9-11, the relief passages 72 are formed through the pressure relief member 20, as described above. Each umbrella valve 22 may include a main securing post 140 that passes through a central valve retaining passage 73 (as shown in FIG. 4), while a flexible cap 142 (that may include the flaps 82 and the central crease 84, as shown in FIG. 5) covers front outlets of the relief passages 72. When pressure of a predetermined magnitude is exerted into the central passage 73 in the direction of arrow P, the flexible cap 142 may flap open in the direction of arrows B, thereby opening the relief passages 72 to relieve fluid pressure therethrough.

The pressure relief member 20, including one or more umbrella valves 22, is configured to accommodate a failed nozzle condition. During normal refueling, air flows through a fuel pipe as fuel enters. A carbon canister holds the air that is ingested into the tank. Hydrocarbons typically build up in the carbon canister, thereby generating internal pressure. The hydrocarbons are generally released when the engine is running. However, in hybrid vehicles, the engine does not always run. As such, the pressure relief member 20 allows the internal pressure caused by the hydrocarbons to be released. For example, the internal pressure exerted into the umbrella valves 22 forces them open, and the hydrocarbons may be vented through the relief passages 72. Once the pressure is reduced below a predetermined, set pressure, the umbrella valves 22 re-seat over the relief passages 72, thereby containing gases within the fuel tank and fuel fill line.

The pressure relief member 20 cooperates with interior portions of the main outer body 12 to provide a pressure chamber that acts as a tortuous path during a failed nozzle event. As such, an individual is protected from being exposed to high pressure fuel spray during a refueling operation.

As shown in FIGS. 1, 7, 8, and 9, in particular, the relief passages 72 are positioned above the central opening 38. The positioning of the relief passages 72, and the umbrella valves 22, above the central opening 38 (and opening or channel through which the nozzle passes) separates the hydrocarbon release channel and the fuel intake channel, as defined by the nozzle passage (including the central opening 38). Accordingly, the relief passages 72 may be distally located from the central opening 38 and nozzle channel. The separation of the relief passages 72 from the central opening 38 and nozzle channel may limit, reduce, minimize, or otherwise prevent hydrocarbons permeating into the fuel. Additionally, because the relief passages 72 and the umbrella valves 22 are separated from the central opening 38 and the nozzle passage, the umbrella valves 22 may be removed and replaced without affecting the sealing strength and ability of the seal member 18.

While the assembly 10 is shown and described having two umbrella valves 22 secured to the pressure relief member 20, more or less umbrella valves 22 may be used. For example, the assembly 10 may include one, three, four, five, or more umbrella valves 22. In general, more umbrella valves 22 allow for increased fluid flow during a failed nozzle condition. For example, two umbrella valves 22 allow for twice the amount of fluid pressure relief in comparison to just one umbrella valve.

Accordingly, the fuel nozzle-receiving assembly 10 sealingly engages the fuel nozzle, thereby preventing fuel from back-flowing out of the fuel fill line and air from passing into the fuel fill line, while at the same time providing a pressure relief member that allows hydrocarbons to be released from the fuel fill line and fuel tank when a pressure threshold is exceeded.

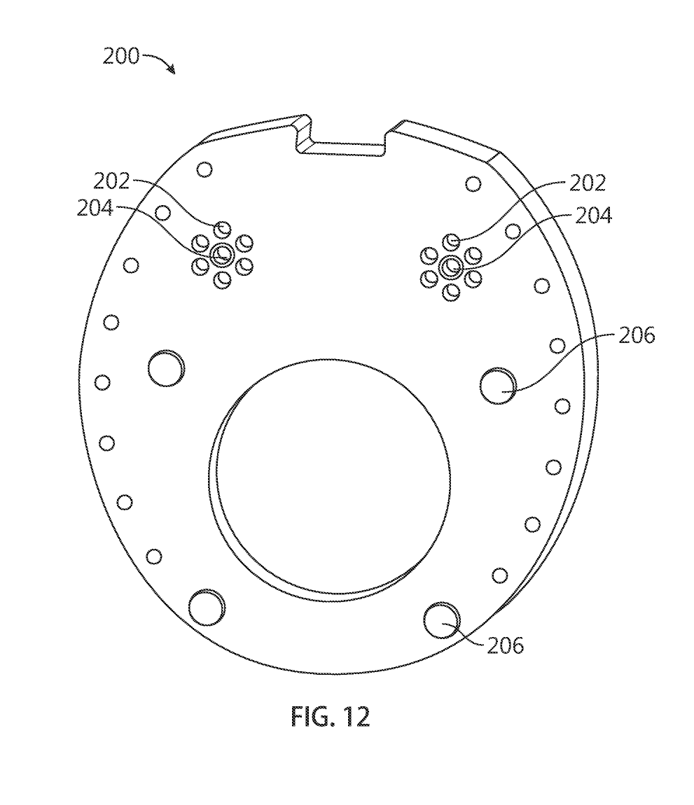

FIG. 12 illustrates an isometric front view of a pressure relief member 200, according to an embodiment of the present disclosure. The pressure relief member 200 is similar to the pressure relief member 20 described above. However, the pressure relief member 200 may be sized and shaped differently than the pressure relief member 20. In general, the pressure relief members 20 and 200 may be sized and shaped in any manner that allows them to be secured within a main outer body of a fuel nozzle-receiving assembly. The sizes and shapes shown in the Figures are in no way limiting.

Similar to the pressure relief member 20, the pressure relief member 200 includes relief passages 202 surrounding a valve insertion channel 204. An umbrella valve including a securing post may be secured into the valve insertion channel 204, and may be configured to have a flap portion that covers the relief passages 202, as described above. The pressure relief member 200 also includes securing members 206 configured to be securely retained within reciprocal channels of a seal member.

The pressure relief member 200 may be formed through injection molding, for example. For example, the pressure relief member 200 may be formed through a first shot of injection molded plastic.

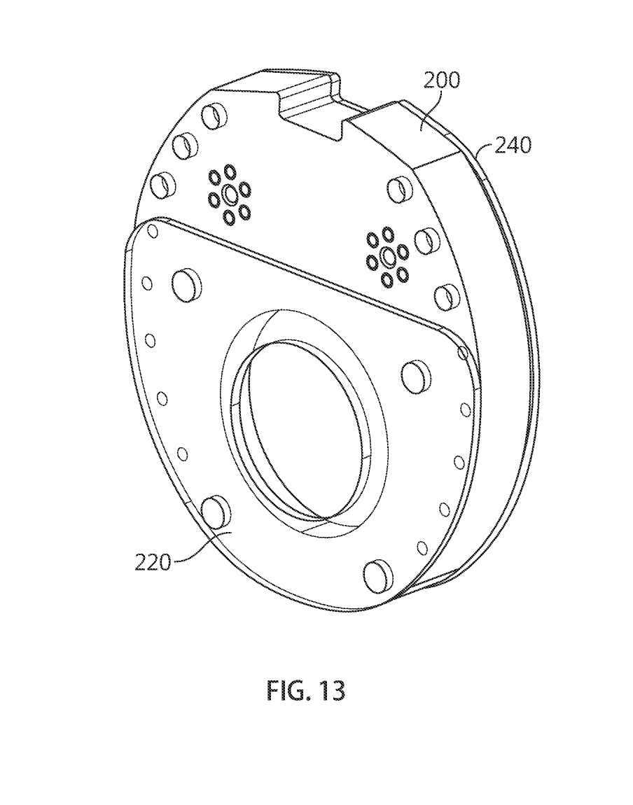

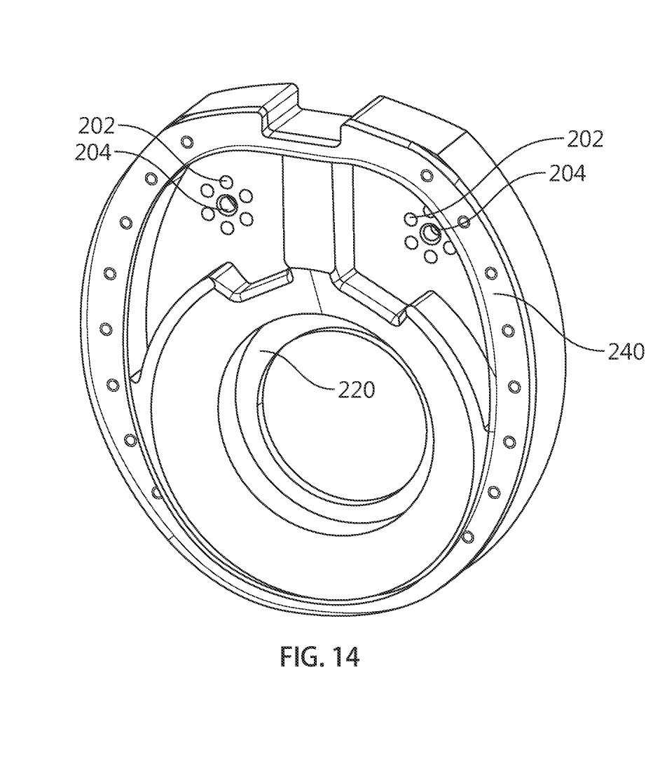

FIG. 13 illustrates an isometric front view of a seal member 220 secured to the pressure relief member 200, according to an embodiment of the present disclosure. FIG. 14 illustrates an isometric rear view of the seal member 220 secured to the pressure relief member 200, according to an embodiment of the present disclosure. As shown in FIGS. 13 and 14, a peripheral gasket 240 may be overmolded onto a rear edge periphery of the pressure relief member 200. The gasket 240 may be formed of injection molded plastic, rubber, or the like. The gasket 240 may be rubber, for example, that is softer than the plastic of the pressure relief member 200. The gasket 240 may be formed of the same material as the seal member 220. The pressure relief member 200, the seal member 220, and the gasket 240 may be integrally molded and formed within a single mold. For example, the plastic material of the pressure relief member 200 may be injected first into the mold. After the material cools and hardens, rubber may be injected into the mold to form the gasket 240 and/or the seal member 220.

The unitary pressure relief member 200, seal member 220, and the gasket 240 may be used with respect to any of the embodiments of present disclosure. For example, the unitary pressure relief member 200, seal member 220, and the gasket 240 may be used in place of the pressure relief member 20, the seal member 18, and the gasket 90 described with respect to FIGS. 1-11.

The seal member 220 may be formed of thermoplastic elastomer (TPE), for example. As such, the seal member 220 may form a chemical bond when overmolded onto the pressure relief member 200. The gasket 240 may also be formed of TPE and overmolded to the pressure relief member 200. The chemical bond between the seal member 220/gasket 240 and the pressure relief member 200 prevents leakage between therebetween.

Further, by utilizing an overmold process, the manufacturing process is simplified in that, instead of manufacturing three separate parts, a single, unitary construction may be molded and formed.

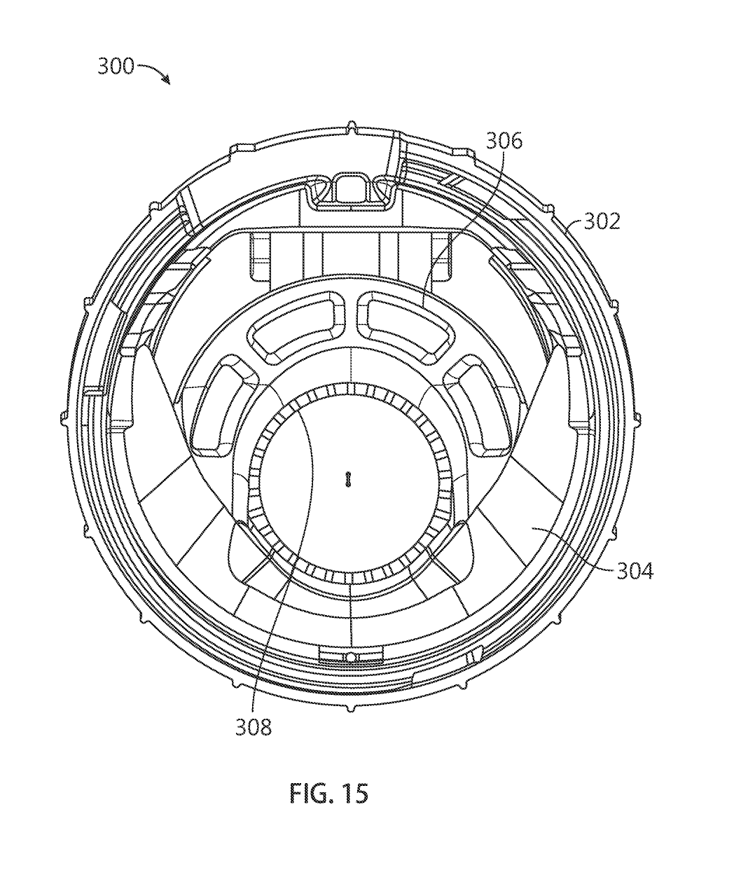

FIG. 15 illustrates a front view of a fuel nozzle-receiving assembly 300, according to an embodiment of the present disclosure. The assembly 300 includes a main outer body 302, a nozzle guide 304, a nozzle stop 306, and a seal member 308. The main outer body 302 and the nozzle guide 304 may be similar to those described above. The nozzle stop 306 may be an inhibitor nozzle stop configured to prevent a fuel nozzle from being inserted too deep into a fuel fill line.

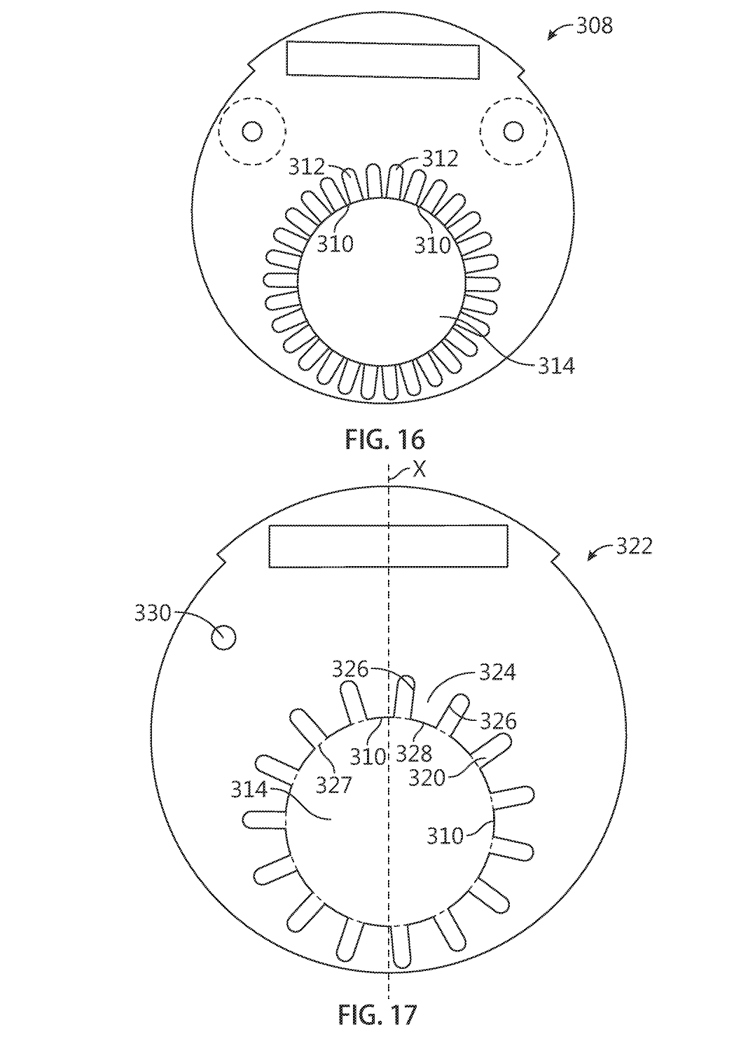

FIG. 16 illustrates a front view of the seal member 308, according to an embodiment of the present disclosure. The seal member 308 may be formed of a flat, planar sheet of rubber, TPE, or the like. The seal member 308 may include a plurality of inwardly-directed nozzle-engagers 310 separated by gaps 312. The nozzle-engagers 310 may be flexible fingers, arms, or the like. The nozzle-engagers 310 may extend regularly around a central opening 314. Each nozzle-engager 310 may be formed as a trapezoid; however, the nozzle-engagers 310 may be formed of various other shapes, such as triangles, rectangles, or the like. The nozzle-engagers 310 are configured to flex in order to allow a nozzle to pass through the central opening 314. As the nozzle-engagers 310 flex and deflect, the nozzle-engagers 310 sealingly engage the outer shaft of the nozzle. While shown as a single piece, the seal member 308 may be formed through two identical pieces that overlap one another in a reverse, flipped manner.

FIG. 17 illustrates a front view of a seal member component 322, according to an embodiment of the present disclosure. The seal member 308 shown in FIG. 16 may be formed by two seal member components 322 overlaying one another, but in a flipped, reverse fashion.

Each seal member component 322 may include nozzle-engagers 310 separated by gaps 320. Each nozzle-engager 310 may include a distal base 324 connected to inwardly-canted lateral walls 326, which, in turn, connect to a tip 328. Each lateral wall 326 may be oriented at an angle with respect to a tangent of a circular inner opening 327 of the central opening 314. The tip 328 may be shorter than the base 324. Accordingly, the nozzle-engagers 310 may be formed as trapezoids. Each seal member half 322 may include fifteen nozzle-engagers 310 surrounding the central opening 314. However, each seal member half 322 may include more or less nozzle-engagers 310 than shown.

The seal member half 322 also includes a locating hole 330 formed above the level of the central opening 314. The locating hole 330 is offset to one side of a central axis x. Referring to FIGS. 16 and 17, in order to form the seal member, one seal member component 322 may be positioned over another seal member component 322 such that the locating hole 330 of the first seal member component 322 is on one side of the central axis x, while the locating hole 330 of the second seal member component 322 is on an opposite side of the central axis x. In this manner, the nozzle-engagers 310 of the first seal member 322 may overlay the gaps 320 of the second seal member 322, and vice versa.

When the two seal member components 322 overlay one another, as described above, each locating hole 330 may be covered by the material of the opposite seal member half 322. Further, the nozzle-engagers 310 overlap one another to provide an inner circumferential edge surrounding the central opening 314 that provides a sealing interface with an outer surface of a fuel nozzle. The overlapping nozzle-engagers 310 provide a complete, contiguous sealing interface with an outer surface of a fuel nozzle.

Alternatively, instead of using two seal member components 322, the seal member 308 may be formed by a single seal member half 322. Additionally, alternatively, the seal member 308 may be formed by three or more seal member components 322 overlaying one another.

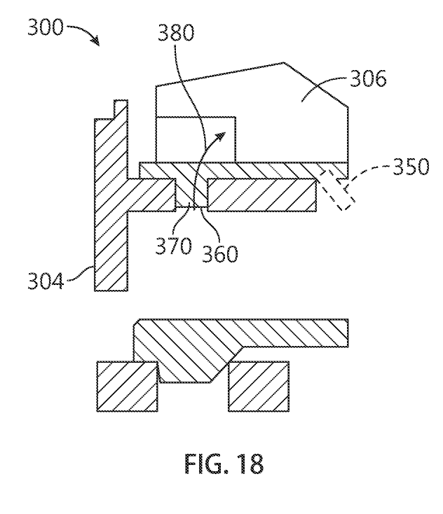

FIG. 18 illustrates an interior transverse cross-sectional view of the fuel nozzle-receiving assembly 300, according to an embodiment of the present disclosure. The assembly 300 may include a pressure relief member 350 operatively connected to one or both of the nozzle guide 304 and/or the nozzle stop 306. A pressure relief passage 360 may be formed through a portion of the nozzle guide 304 and/or the nozzle stop 306. The pressure relief member 350 may include an anchored portion 362 compressively sandwiched between the nozzle guide 304 and the nozzle stop 306. The anchored portion 362 integrally connects to a valve member 370 sealingly secured within the pressure relief passage 360. When pressure exceeds a predetermined threshold, the pressure exerted into the valve member 370 forces the valve member 370 out of the pressure relief passage 360. The valve member 370 pivots open in the direction of arc 380. Fluid pressure, such as due to hydrocarbon pressure, is then released through the pressure relief passage 360. When the pressure recedes below the pressure threshold, the valve member 370 pivots back into the pressure relief passage 360. As such, the assembly 300 may include an integral valve member 370, as opposed to separate and distinct valves, such as umbrella valves. The integral valve member 370 may sealingly engage a pressure relief passage formed through various parts of the assembly 300, including interior portions of the main outer body 302, the nozzle guide 304, the nozzle stop 306, and/or the like. The depiction with respect to the nozzle guide 304 and/or the nozzle stop 306 is merely illustrative and exemplary.

The assembly 300 may alternatively include a pressure relief member and umbrella valves as shown in FIG. 1, for example. Further, the pressure relief member 350 shown and described with respect to FIG. 18 may be used with respect to any of the embodiments of the present disclosure.

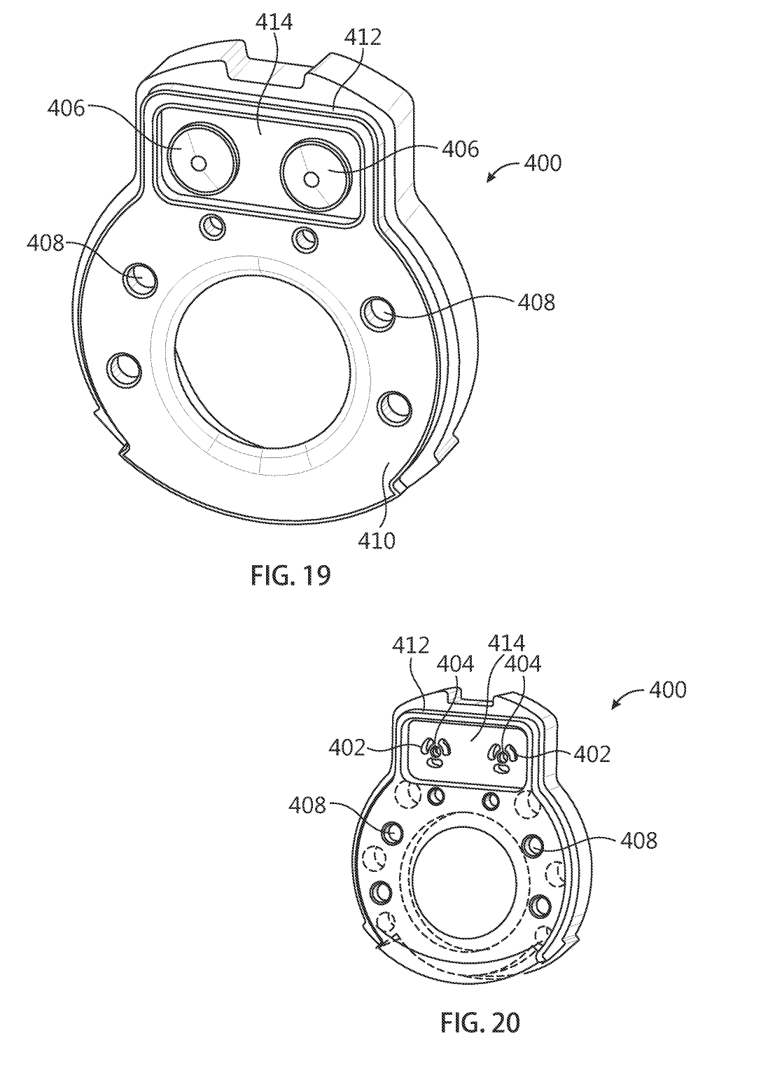

FIG. 19 illustrates an isometric front view of a pressure relief member 400, according to an embodiment of the present disclosure. The pressure relief member 400 is similar to the pressure relief members 20 and 200 described above. However, the pressure relief member 400 may be sized and shaped differently than the pressure relief members 20 and 200. In general, the pressure relief members 20, 200, and 400 may be sized and shaped in any manner that allows them to be secured within a main outer body of a fuel nozzle-receiving assembly. The sizes and shapes shown in the Figures are in no way limiting.

FIG. 20 illustrates an isometric front view of the pressure relief member 400 with valves removed from relief passages 402, according to an embodiment of the present disclosure. Referring to FIGS. 19 and 20, similar to the pressure relief members 20 and 200, the pressure relief member 400 includes the relief passages 402 surrounding a valve insertion channel 404. An umbrella valve 406 including a securing post may be secured into the valve insertion channel 404, and may be configured to have a flap portion that covers the relief passages 402, as described above. As shown in FIG. 20, three relief passages 402 are positioned around each central insertion channel 404. The pressure relief member 400 may also include securing members 408 that are securely retained within reciprocal channels of a seal member 410. The seal member 410 may also include an upper bracket 412 that secures around a reciprocal raised surface 414 of the pressure relief member 400. The upper bracket 412 may secure to the raised surface 414 through an interference fit, a snap-engagement, or the like. The upper bracket 412 provides additional retaining force for securing the seal member 410 to the pressure relief member 400.

The pressure relief member 400 may be formed through injection molding, for example. For example, the pressure relief member 400 may be formed through a first shot of injection molded plastic.

The pressure relief member 400 and the seal member 410 may be used with respect to any of the embodiments of present disclosure. For example, the pressure relief member 400 and the seal member 410 may be used in place of the pressure relief member 20, the seal member 18, and the gasket 90 described with respect to FIGS. 1-11.

Referring to FIGS. 1-20, embodiments of the present disclosure provide fuel nozzle-receiving assemblies that are configured to sealingly engage a fuel nozzle, so that fuel does not backflow out of the fuel fill line. Moreover, the sealing engagement between the seal member and the fuel nozzle prevents air from passing into the fuel fill line and into the fuel tank. Further, the seal member also prevents gases from escaping out of the fuel fill line. Additionally, embodiments of the present disclosure provide fuel nozzle-receiving assemblies that are configured to allow hydrocarbon pressure to be released when a pressure threshold is exceeded. As such, pressure within the fuel system is relieved before it builds to dangerous levels.

Embodiments of the present disclosure may be used with respect to capped or capless fuel systems.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

Various features of the disclosure are set forth in the following claims.

1. A fuel nozzle-receiving assembly configured to be operatively connected to a fuel fill line of a fuel intake system of a vehicle, the fuel nozzle-receiving assembly comprising:
a main outer body;
a pressure relief member secured to and within the main outer body, wherein the pressure relief member comprises at least one valve operatively connected to at least one relief passage, wherein the at least one valve is configured to open to allow fluid pressure to be released through the at least one relief passage when the fluid pressure exceeds a pressure threshold; and
a seal member secured to the pressure relief member, wherein the seal member defines a central opening configured to receive a fuel nozzle, and wherein the seal member is configured to sealingly engage an outer shaft of the fuel nozzle to prevent fuel from back-flowing out of the fuel fill line and air from passing into the fuel fill line.

2. The fuel nozzle-receiving assembly of claim 1, wherein the at least one valve comprises at least one umbrella valve having opposed flaps that cover the at least one relief passage in a closed position.

3. The fuel nozzle-receiving assembly of claim 1, wherein the at least one valve comprises an anchored portion operatively connected to a valve member configured to pivot into and out of the at least one relief passage.

4. The fuel nozzle-receiving assembly of claim 1, further comprising a nozzle guide configured to guide the fuel nozzle into the central opening, wherein the seal member is securely sandwiched between the pressure relief member and the nozzle guide.

5. The fuel nozzle-receiving assembly of claim 1, further comprising a gasket secured to a portion of the pressure relief member, wherein the gasket provides a sealing interface between the pressure relief member and the main outer body, wherein the sealing interface prevents fluid from passing therethrough.

6. The fuel nozzle-receiving assembly of claim 1, wherein the pressure relief member and the gasket are integrally overmolded together as a single piece.

7. The fuel nozzle-receiving assembly of claim 1, wherein the pressure relief member comprises at least one securing member that is securely retained within at least one retaining passage formed through the seal member.

8. The fuel nozzle-receiving assembly of claim 1, wherein the pressure relief member and the seal member are integrally overmolded together as a single piece.

9. The fuel nozzle-receiving assembly of claim 1, wherein the seal member comprises a plurality of nozzle engagers surrounding the central opening.

10. The fuel nozzle-receiving assembly of claim 9, wherein the seal member comprises a first seal member component overlaying a second seal member component.

11. The fuel nozzle-receiving assembly of claim 10, wherein a first set of nozzle engagers of the first seal member overlaps a second set of nozzle engagers of the second seal member.

12. A fuel nozzle-receiving assembly configured to be operatively connected to a fuel fill line of a fuel intake system of a vehicle, the fuel nozzle-receiving assembly comprising:
a pressure relief member including at least one valve operatively connected to at least one relief passage, wherein the at least one valve is configured to open to allow fluid pressure to be released through the at least one relief passage when the fluid pressure exceeds a pressure threshold; and
a seal member secured to the pressure relief member, wherein the seal member defines a central opening configured to receive a fuel nozzle, and wherein the seal member is configured to sealingly engage an outer shaft of the fuel nozzle to prevent fuel from back-flowing out of the fuel fill line and air from passing into the fuel fill line.

13. The fuel nozzle-receiving assembly of claim 12, wherein the at least one valve comprises at least one umbrella valve having opposed flaps that cover the at least one relief passage in a closed position.

14. The fuel nozzle-receiving assembly of claim 12, wherein the at least one valve comprises an anchored portion operatively connected to a valve member configured to pivot into and out of the at least one relief passage.

15. The fuel nozzle-receiving assembly of claim 12, further comprising a gasket secured to a portion of the pressure relief member.

16. The fuel nozzle-receiving assembly of claim 12, wherein the pressure relief member comprises at least one securing member that is securely retained within at least one retaining passage formed through the seal member.

17. The fuel nozzle-receiving assembly of claim 12, wherein the seal member comprises a first seal member component overlaying a second seal member component, and wherein a first set of nozzle engagers of the first seal member overlaps a second set of nozzle engagers of the second seal member.

18. A fuel nozzle-receiving assembly configured to be operatively connected to a fuel fill line of a fuel intake system of a vehicle, the fuel nozzle-receiving assembly comprising:
a main outer body configured to be secured on or within a portion of the fuel fill line;
a pressure relief member secured to and within the main outer body, wherein the pressure relief member comprises (a) a plurality of valves operatively connected to a plurality of relief passages and (b) at least one securing member, wherein the plurality of valves are configured to open to allow fluid pressure to be released through the plurality of relief passages when the fluid pressure exceeds a pressure threshold;
a gasket secured to a portion of the pressure relief member, wherein the gasket provides a sealing interface between the pressure relief member and the main outer body, wherein the sealing interface prevents fluid from passing therethrough;
a seal member secured to the pressure relief member, wherein the seal member comprises at least one retaining passage configured to securely retain the at least one securing member, wherein the seal member defines a central opening configured to receive a fuel nozzle, and wherein the seal member is configured to sealingly engage an outer shaft of the fuel nozzle to prevent fuel from back-flowing out of the fuel fill line and air from passing into the fuel fill line; and
a nozzle guide configured to guide the fuel nozzle into the central opening, wherein the seal member is securely sandwiched between the pressure relief member and the nozzle guide.

19. The fuel nozzle-receiving assembly of claim 18, wherein each of the plurality of valves comprises an umbrella valve.

20. The fuel nozzle-receiving assembly of claim 18, wherein the seal member comprises a first seal member component overlaying a second seal member component, and wherein a first set of nozzle engagers of the first seal member overlaps a second set of nozzle engagers of the second seal member.
